(19) United States
(12) Patent Application Publication
(10) Pub. No.: US 2012/0192691 A1
(43) Pub. Date: Aug. 2, 2012

(54) MEDIA PUNCH AND METHODS

(76) Inventors: Andrew Jonathan Hiller, Farmington, UT (US); Jennifer Lynn Garry, Pleasant Grove, UT (US); Tavnir John Carey, West Jordan, UT (US)

(21) Appl. No.: 13/016,952

(22) Filed: Jan. 28, 2011

(51) Int. Cl. B26F 1/38; B26F 1/44; B26D 5/02

(52) U.S. Cl. 83/39; 83/549; 83/13

(57) ABSTRACT

A media punch includes an outer cutter configured to cut a fractional outer border pattern in a media sheet. The media punch also includes an inner cutter configured to cut a fractional inner pattern in a media sheet. The fractional inner pattern is interior to the fractional outer border pattern within the media sheet. The media punch also includes a selector configured to move between an outer cut position to engage the outer cutter alone, an inner cut position to engage the inner cutter alone, and a combination cut position to engage both the inner cutter and the outer cutter.

### BACKGROUND

Punches are often used to cut a design into media, such as paper, plastic, or other media. This may be particularly useful in scrapbooking, such as for making customized backgrounds and/or borders. Current punches often form a single, complete pattern with each cut. While such an approach allows for the application of a pattern, this approach is limited to the single, complete pattern.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In at least one example, a media punch includes an outer cutter configured to cut a fractional outer border pattern in a media sheet. The media punch may also include an inner cutter configured to cut a fractional inner pattern in a media sheet. The fractional inner pattern may be interior to the fractional outer border pattern within the media sheet. The media punch may also include a selector configured to move between an outer cut position to engage the outer cutter alone, an inner cut position to engage the inner cutter alone, and a combination cut position to engage both the inner cutter and the outer cutter.

A method of cutting a pattern into a sheet of media may include placing a media sheet into a media punch. Such a media punch may include an outer cutter configured to cut a fractional outer border pattern in the media sheet and an inner cutter configured to cut a fractional inner pattern in the media sheet. The fractional inner pattern is interior to the fractional outer border pattern within the media sheet. A media punch according to such a method may include a selector configured to move between an outer cut position to engage the outer cutter alone, an inner cut position to engage the inner cutter alone, and a combination cut position to engage both the inner cutter and the outer cutter. Such a method includes moving the selector into a first of the outer cut position, the inner cut position, and the combination cut position. A handle is also actuated to perform a first cut according to the position of the selector.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a top perspective view of a media punch according to one example;

FIG. 1B is a bottom perspective view of a media punch according to one example;

FIG. 2A illustrates a complete outer cut formed by a media punch according to one example;

FIG. 2B illustrates a complete inner cut formed by a media punch according to one example;

FIG. 2C illustrates a complete combination cut formed by a media punch according to one example;

FIGS. 3A-3H illustrate a method of forming a combination cut using a media punch according to one example;

FIGS. 4A-4B are schematic diagrams of the function of a media punch according to one example;

FIGS. 5A-5B are schematic diagrams of the function of a media punch according to one example;

FIGS. 6A-6B are schematic diagrams of the function of a media punch according to one example; and

FIGS. 7-11 are top views of media punches according to various examples.

### DETAILED DESCRIPTION OF SOME EXAMPLE EMBODIMENTS

Media punches and methods for forming pattern for media are provided herein. As shown herein, the selector may be selected as desired with each cut. As described herein, media punches are provided herein that allow for selection of a fractional inner cut, a fractional outer cut, or a combination of the two with a single device on a per cut basis. Such a configuration allows for the selection of fractional outer borders, fractional inner borders, complete outer borders, complete inner borders, as well as combinations thereof. Such a configuration allows for the selection of fractional outer borders, fractional inner borders, complete outer borders, complete inner borders, as well as combinations thereof. Such a selection may provide a wide range of customization options for users in a single device.

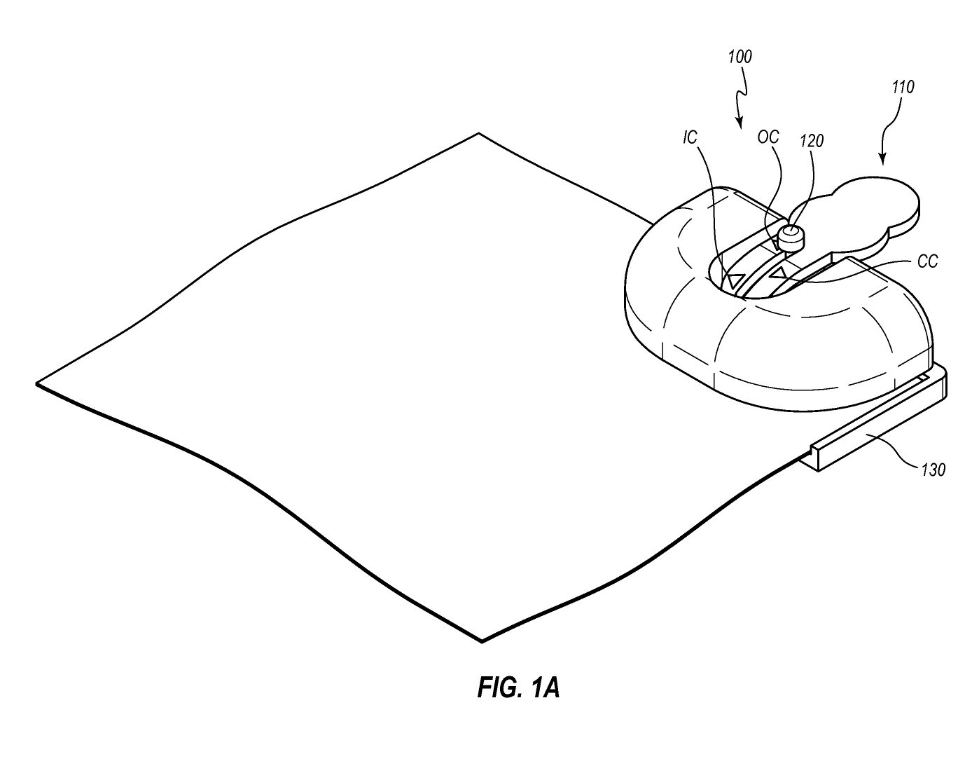

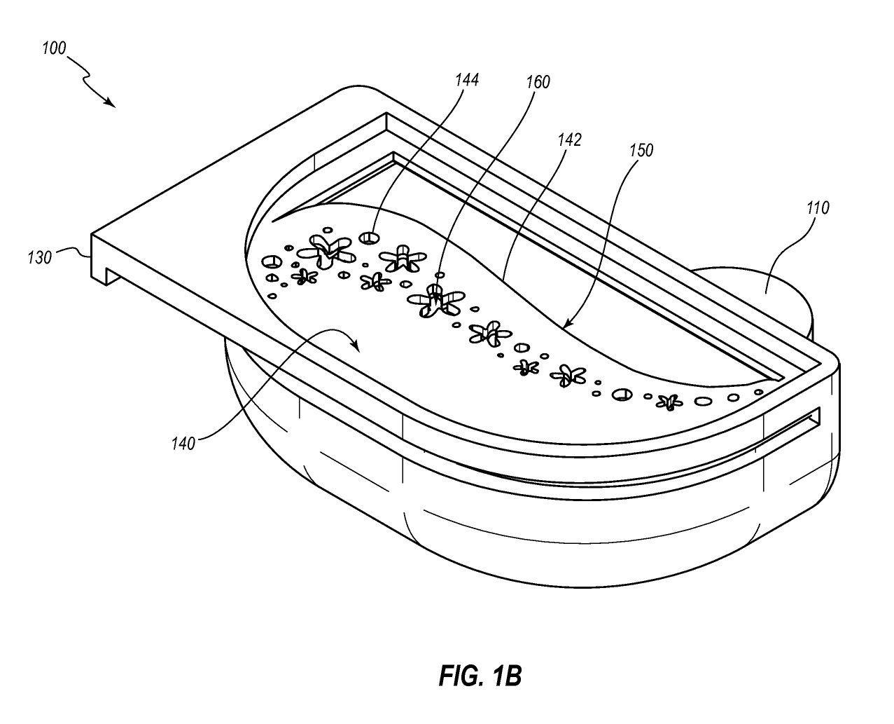

FIG. 1A is a top perspective view of a media punch 100 according to one example. As illustrated in FIG. 1A, the media punch 100 generally includes a lever handle 110 and a cutter selector 120, and an alignment guide 130. As will be discussed in more detail hereinafter, the cutter selector 120 may be moved to position OC to allow the media punch 100 to perform an outer cut, to position IC to perform an inner cut, or to position CC to perform a combination inner/outer cut when the lever handle 110 is actuated. In at least one example, the lever handle 110 is actuated by pushing the lever handle 110 toward the alignment guide 130.

As shown in FIG. 1B, the media punch 100 includes a cutter guide 140 operatively associated with the alignment guide 130, outer cutters 150, and inner cutters 160 (both positioned in a recessed position within the media punch 100). Referring simultaneously to FIGS. 1A and 1B, when the cutter selector 120 is at position OC the lever handle 110 will operate to move the outer cutters 150. When the cutter selector 120 is at position IC, the lever handle 110 will operate to move the inner cutters 160. When the cutter selector 120 is at position CC the lever handle 110 will operator to move both the outer cutters 150 and the inner cutters 160. Exemplary functionality of selectors will be described in more detail at appropriate points hereinafter.

As the outer cutters 150 and/or the inner cutters 160 move in response to the actuation of the lever handle 110, the outer cutters 150 and/or the inner cutters 160 cut corresponding patterns into a media sheet positioned in the media punch 100. In particular, the cutter guide 140 has openings defined therein, including outer pattern openings 142 and inner pattern openings 144 that correspond in position, size, and/or shape to the outer cutters 150 and the inner cutters 160 respectively. As a result, as the inner cutters 150 and/or outer cutters 160 pass into the outer pattern openings 142 and/or inner pattern openings 144 media positioned there between is cut with the pattern of the outer cutters 150 and/or the inner cutters 160.

The cutter guide 140 may be integrated with the alignment guide 130 or the cutter guide 140 may be separate from the alignment guide 130 as shown. The alignment guide 130, the cutter guide 140, and/or other structure provide a base from which the lever handle 110 may be actuated. As introduced, actuation of the lever handle 110 performs the cut selected by the position of the selector 120.

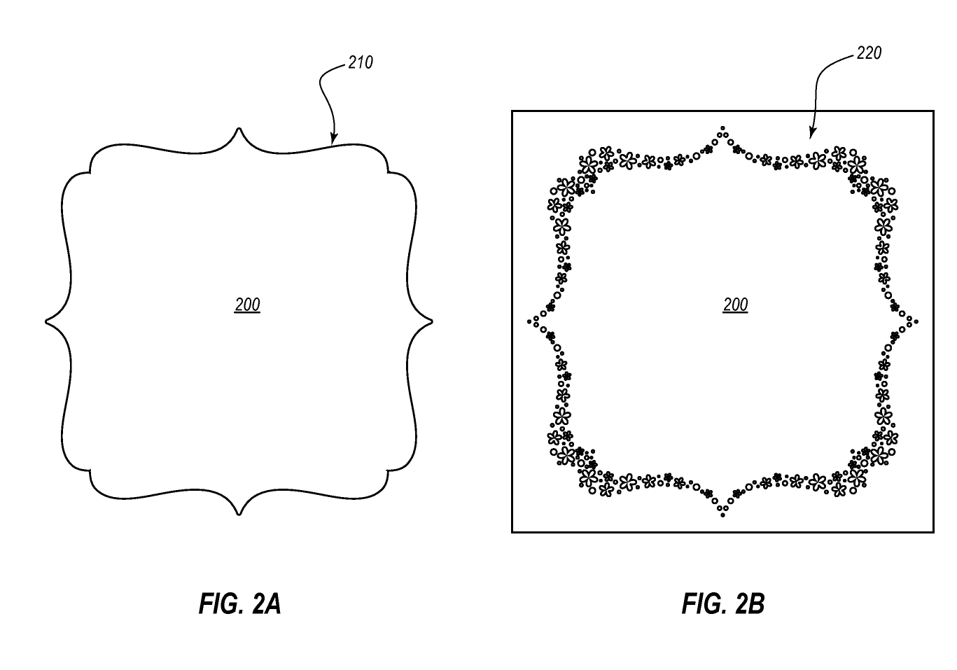

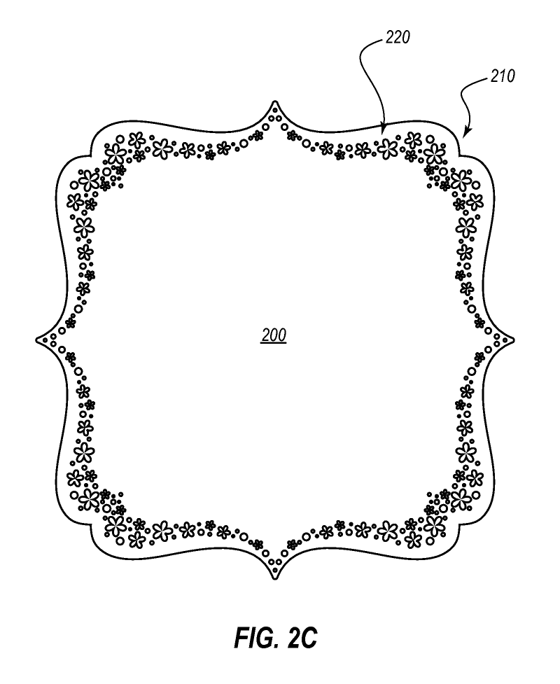

To this point, the cuts performed by the outer cutters 150 and/or the inner cutters 160 have been discussed generally. As will be discussed in more detail hereinafter, the cuts made by media punch 100 may be portions of larger patterns. For example, each cut performed by the media punch 100 may be a fractional portion of a pattern that forms a complete border around a perimeter of the media. Fractional portions shown in the Figs. are ⅛ (eighth) fractional portions, though it will be appreciated that other fractional portions may be implemented as desired. For example, ¼ (quarter) fractional portions may also be provided. Complete border patterns are shown in FIGS. 2A-2C. Though complete border patterns are shown, it will be appreciated that fractional patterns may be applied in any combination, including any combination of outer and inner cuts.

FIG. 2A illustrates a media sheet 200, such as a sheet of paper, which has an exemplary complete outer border 210. FIG. 2B illustrates the media sheet 200 having a complete inner border 220 applied thereto while FIG. 2C illustrate the media sheet 200 having both the complete outer border 210 and the complete inner border 220 applied thereto. The outer border 210, the inner border 220, and/or portions the outer border 210 and the inner border 220 may be cut using a single media punch, such as the media punch 100 which has discussed above with reference to FIGS. 1A and 1B and which will be discussed in more detail hereinafter.

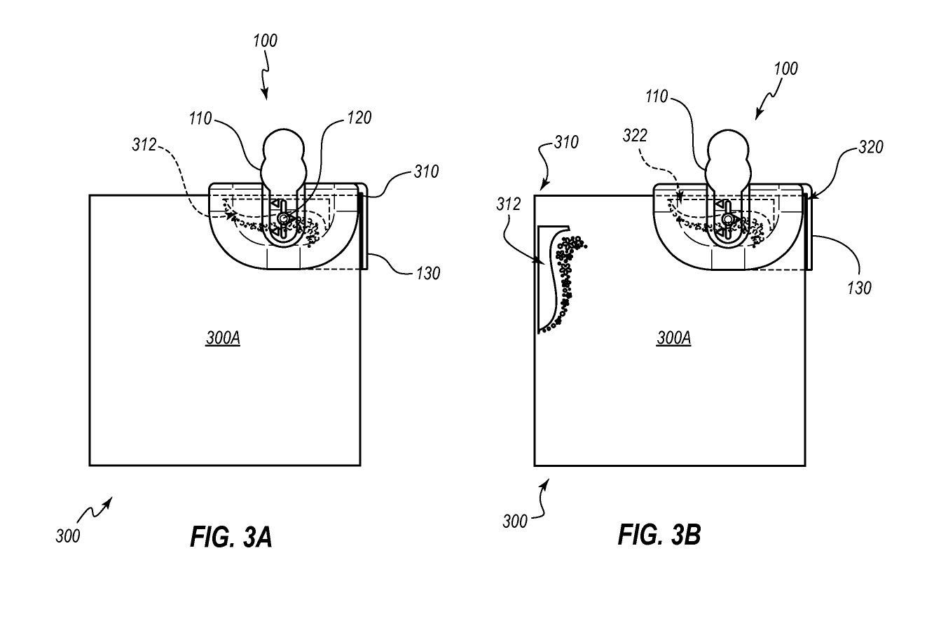

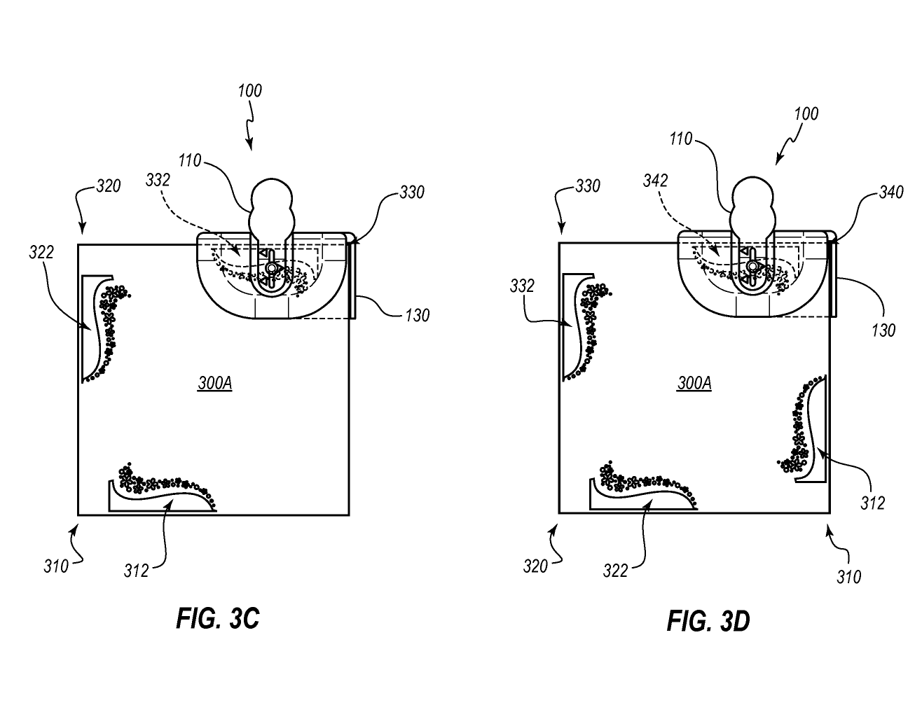

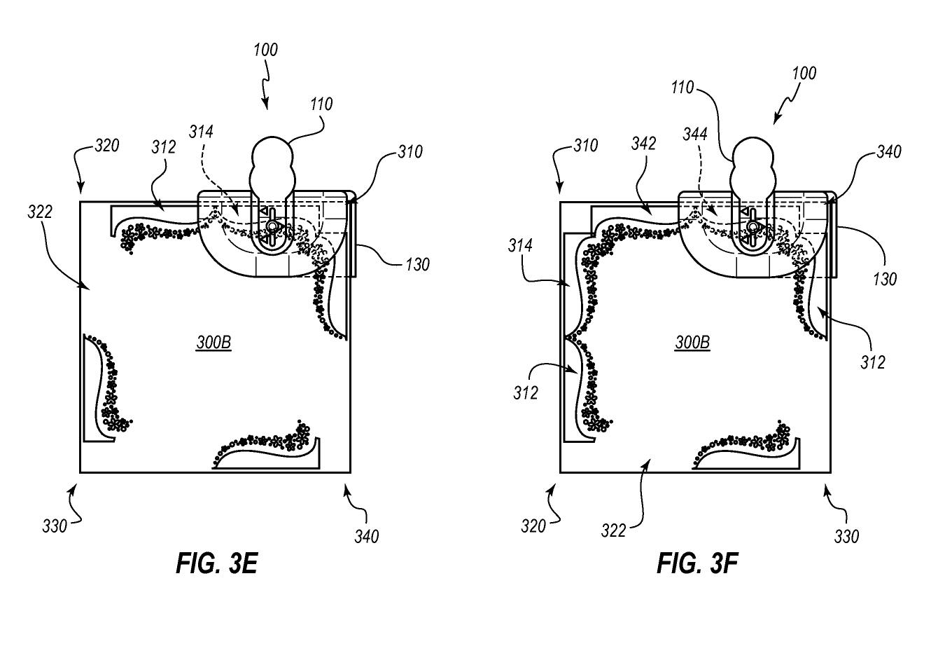

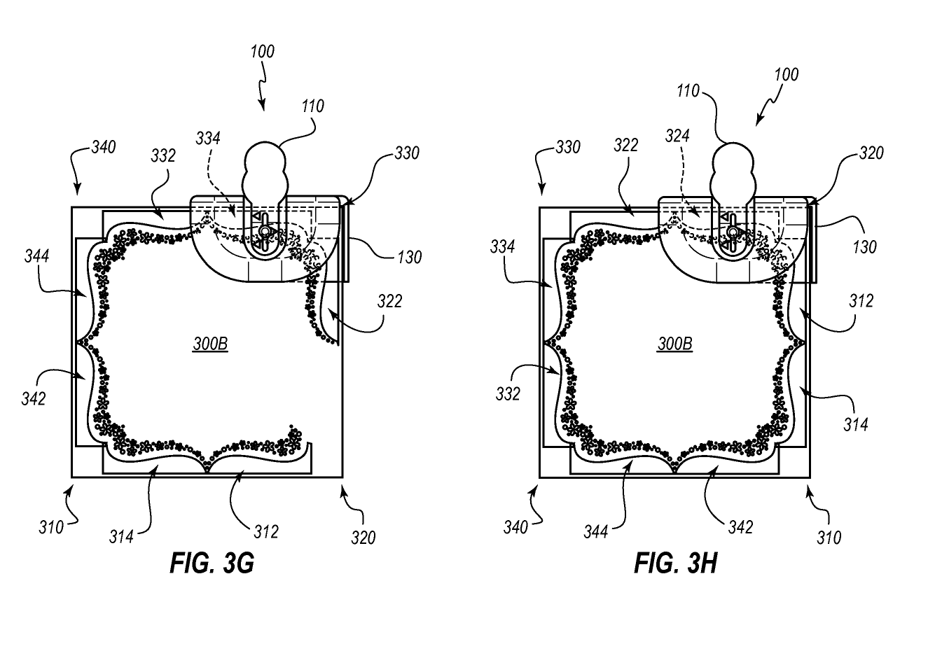

FIGS. 3A-3H illustrate an exemplary method of forming a combination cut in a media sheet 300 using the media punch 100. As illustrated in FIG. 3A, the method begins by positioning a first side 300A of the media sheet 300 on the alignment guide 130. The selector switch 120 is moved to the position corresponding to the desired cut pattern. The method continues by then placing a first corner 310 of the media sheet 300 in position against the alignment guide 130 as shown. The lever handle 110 is then actuated to form a first cut 312.

As shown in FIG. 3B, the media sheet 300 may be rotated to place a second corner 320 against the alignment guide 130 as shown. The lever handle 110 may then be actuated to form a second cut 322. The media sheet 300 is then rotated to place a third corner 330 against the alignment guide 130 and the lever handle 110 is actuated to form a third cut 332 as shown in FIG. 3C. Thereafter the media sheet 300 is rotated to place a fourth corner 340 against the alignment guide 130 and the lever handle 110 is actuated to form a fourth cut 342 as shown in FIG. 3D.

As shown in FIG. 3E, the media sheet 300 may then be flipped to place a second side 300B face up. The media sheet 300 may then be positioned to place the first corner 310 in position against the alignment guide 130 as shown and the lever handle 110 is actuated to form a fifth cut 314.

Again the media sheet 300 may be rotated to move the fourth corner 340 into the position shown in FIG. 3F. The lever handle 110 may then be actuated to form a sixth cut 344. The media sheet 300 may then be rotated to move the third corner 330 into position with the alignment guide 130 as shown in FIG. 3G. The lever handle 110 may then be actuated to form a seventh cut 334. A final cut 324 may then be cut by actuating the lever handle 110 after the media sheet 300 has again been rotated to position the second corner 320 as shown in FIG. 3H.

Accordingly, the media punch 100 may be utilized to perform a series of cuts that together form a border pattern around the perimeter of a media sheet, such as a sheet of paper. As previously introduced, the selector switch 120 may be moved between a plurality of positions. At the various positions, actuation of the lever handle 110 engages different cutters to cut different patterns.

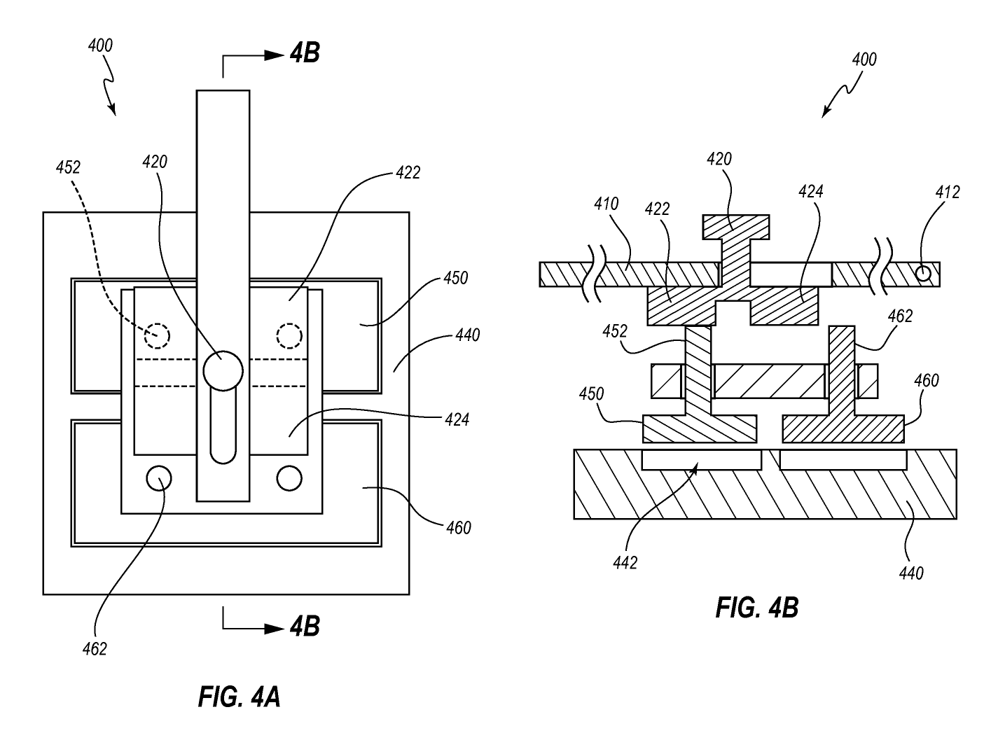

FIGS. 4A-6B illustrate views of an exemplary media punch 400 that illustrate the functional aspects in a schematic fashion. In particular, FIG. 4A illustrates a schematic top view of the media punch 400 while FIG. 4B illustrates a fractional cross sectional view of the media punch 400 taken along section 4B-4B of FIG. 4A. As illustrated in FIGS. 4A and 4B, the media punch 400 generally includes a lever handle 410. The lever handle 410 may be configured to rotate about a fulcrum 412. Though shown as a single-point fulcrum, it will be appreciated that the fulcrum 412 may be a compound fulcrum without departing from the principles described herein.

As shown in FIGS. 4A and 4B, the media punch 400 includes a selector 420 that is operatively associated with the lever handle 410. The selector 420 in turn is coupled to outer transfer bar 422 and inner transfer bar 424. The outer transfer bar 422 is configured to transfer force and movement of the lever handle 410 to an outer cutter 450 by way of outer guides 452 while the inner transfer bar 424 is configured to transfer force and movement of the lever handle 410 to inner cutter 460 by way of inner guide 462.

In the example show in FIGS. 4A and 4B, the media punch 400 is moved to a position in which the outer transfer bar 422 is in position relative to the outer guide 452 while the inner transfer bar 424 is out of position relative to the inner guide 462. In such a position, movement of the lever handle 410 results in movement of the outer cutter 450.

As the outer cutter 450 moves downward, the outer cutter 450 moves into proximity with a cutter guide 440 and into an outer opening 442 in particular. As the cutter 450 thus moves into the opening 442, the outer cutter 450 cuts an outer pattern into any media sheet in position within the media punch 400. In the illustrated example, the pattern is represented schematically as a rectangle, though it will be appreciated that any pattern may be cut.

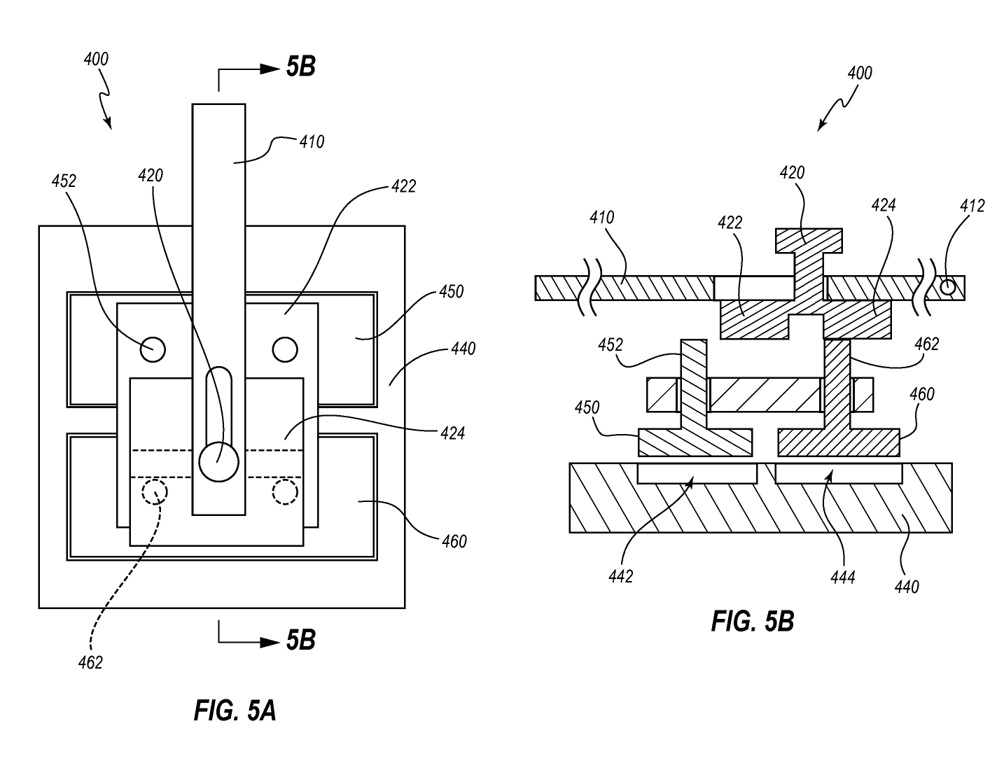

FIGS. 5A-5B illustrate the selector 420 in a position in which the outer transfer bar 422 is out of position relative to the outer guide 452 while the inner transfer bar 424 is in position relative to the inner guide 462. In such a position, movement of the lever handle 410 results in movement of the inner cutter 460.

As the inner cutter 460 moves downward, the inner cutter 460 moves into proximity with the cutter guide 440 and into an inner opening 444 in particular. As the inner cutter 460 thus moves into the opening 444, the inner cutter 460 cuts an inner pattern into any media sheet in position within the media punch 400. In the illustrated example, the pattern is represented schematically as a rectangle, though it will be appreciated that any pattern may be cut.

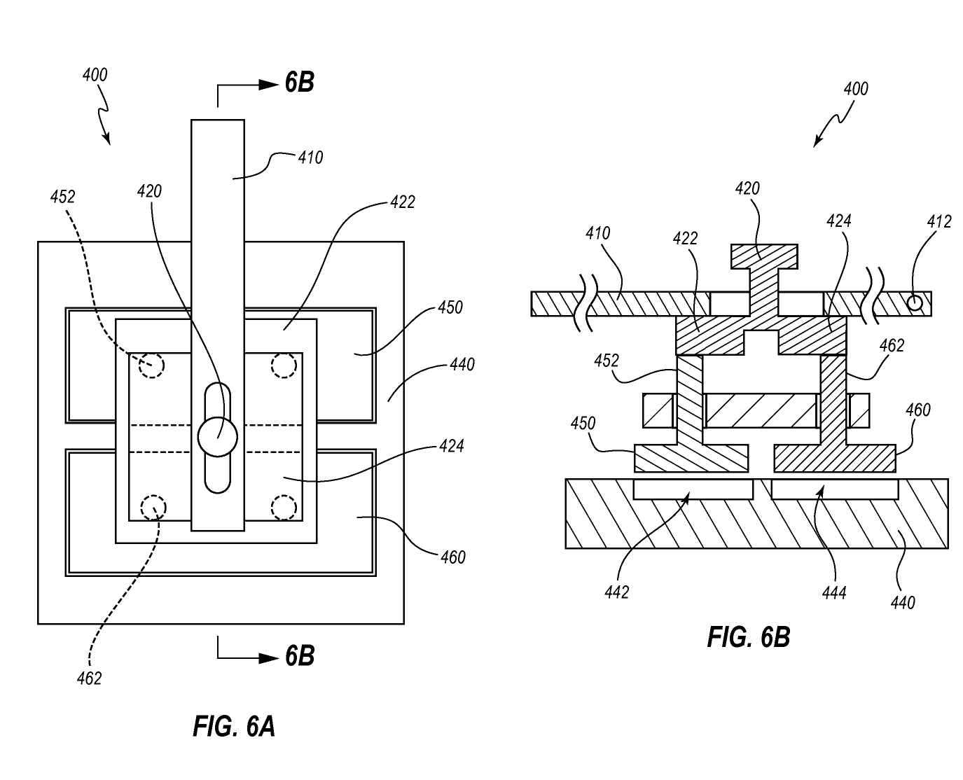

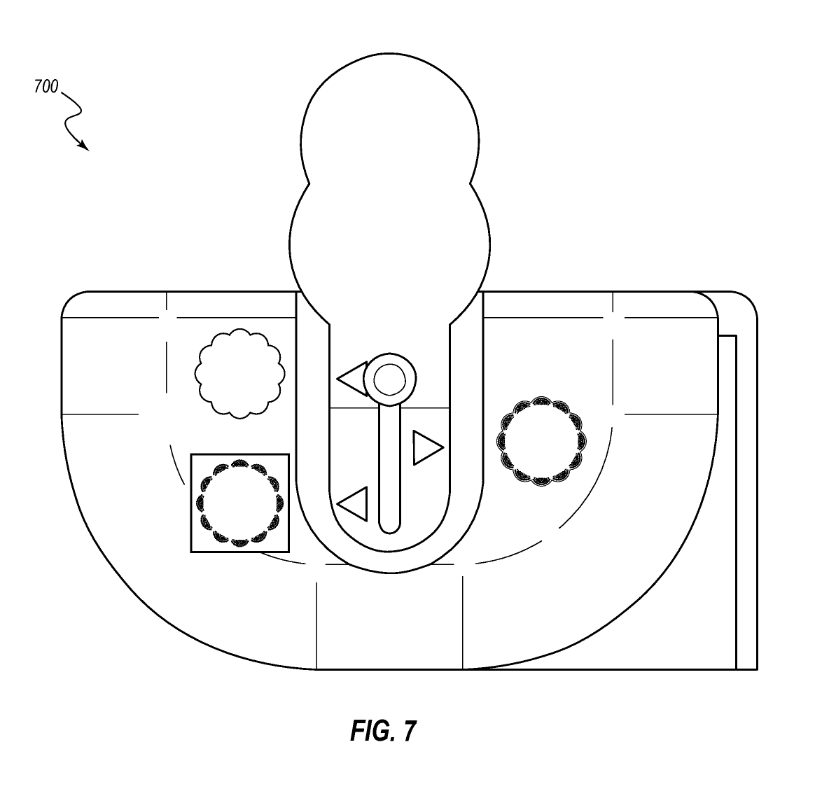

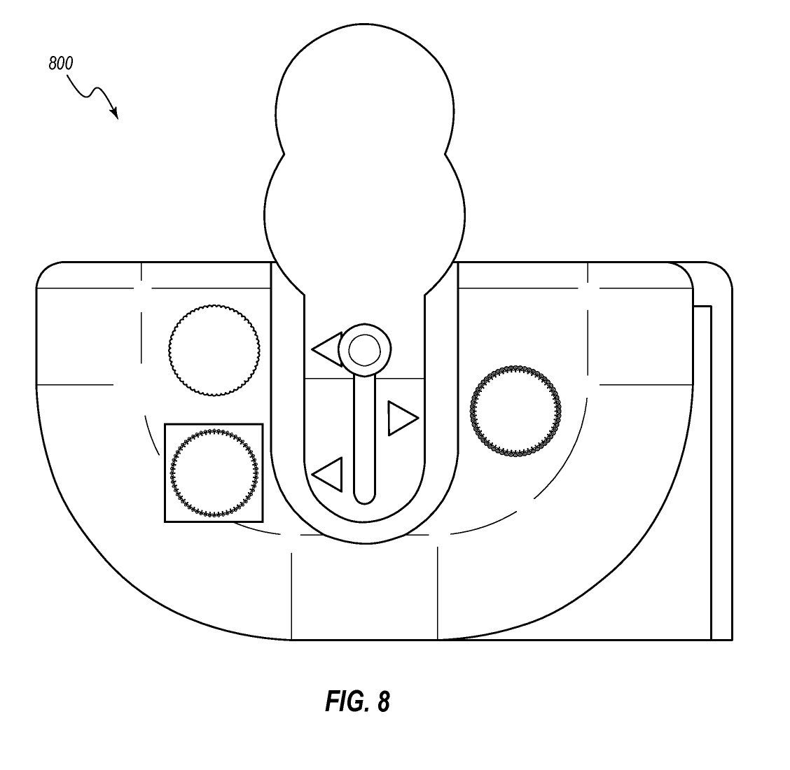

FIGS. 6A-6B illustrate the selector 420 in a position in which the outer transfer bar 422 is in position relative to the outer guide 452 and the inner transfer bar 424 is also in position relative to the inner guide 462. In such a position, movement of the lever handle 410 results in movement of the outer cutter 450 as well as the inner cutter 460, thereby allowing the media punch 400 to perform a combination outer/inner cut. As shown herein, the selector 420 may be selected as desired with each cut. Such a configuration allows for the selection of fractional outer borders, fractional inner borders, complete outer borders, complete inner borders, as well as combinations thereof. Such a selection may provide a wide range of customization options for users in a single device.

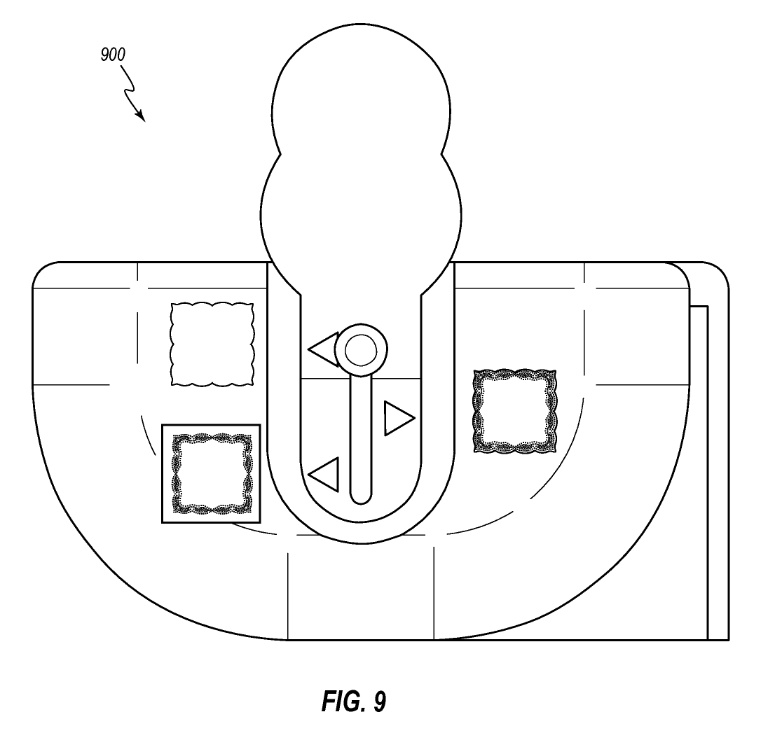

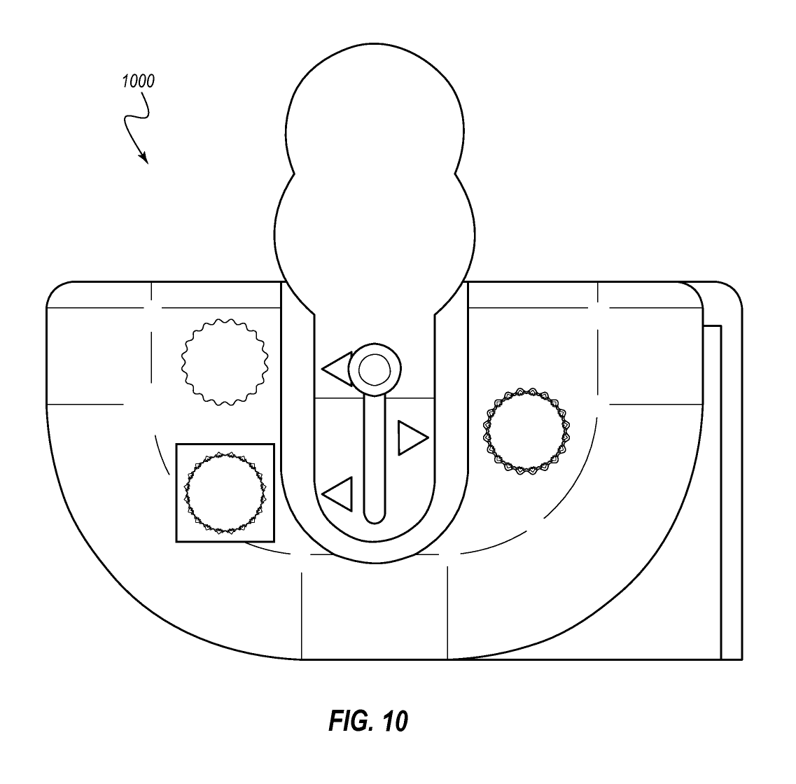

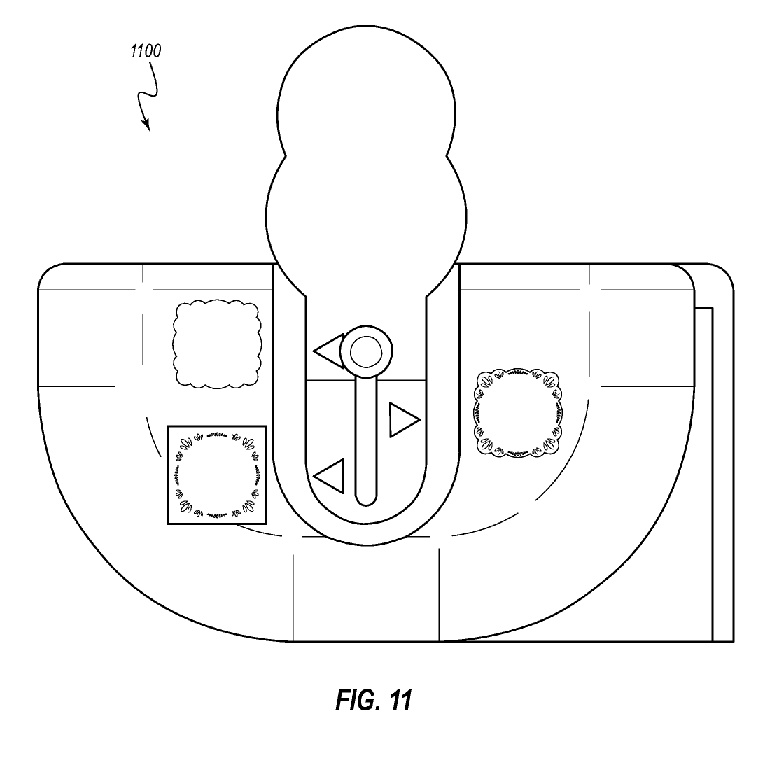

To this point, a single set of patterns have been described. It will be appreciated, however, that any number of patterns may be provided. In particular, FIGS. 7-11 illustrate media punches 700-1100 configured to generate a variety of patterns, which are shown associate with the media punches.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A media punch, comprising:
an outer cutter configured to cut a fractional outer border pattern in a media sheet;
an inner cutter configured to cut a fractional inner pattern in a media sheet, the fractional inner pattern being interior to the fractional outer border pattern within the media sheet; and
a selector configured to move between an outer cut position to engage the outer cutter alone, an inner cut position to engage the inner cutter alone, and a combination cut position to engage both the inner cutter and the outer cutter.

2. The media punch of claim 1, wherein the fractional outer border pattern is ⅛ of a complete border pattern.

3. The media punch of claim 1, wherein the fractional outer border pattern is ¼ of a complete border pattern.

4. The media punch of claim 1, further comprising a lever handle operative associated with the selector, wherein actuation of the lever handle causes the outer cutter to move when the selector is at the outer cut position, the inner cutter to move when the selector is at the inner cut position, and the inner cutter and the outer cutter to move when the selector is at the combination cut position.

5. The media punch of claim 4, further comprising an inner transfer bar and an outer transfer bar coupled to the selector, wherein the inner transfer bar is configured to transfer movement of the lever handle to the outer cutter move when the selector is at the outer cut position, the inner transfer bar is configured to transfer movement of the lever handle to the inner cutter when the selector is at the inner cut position, and inner transfer bar and the outer transfer bar are configured to transfer movement of the lever handle to the inner cutter and the outer cutter when the selector is at the combination cut position.

6. The media punch of claim 5, further comprising outer guides coupled to the outer cutters, the outer guides being configured to engage the outer transfer bar.

7. The media punch of claim 5, further comprising inner guides coupled to the inner cutters, the inner guides being configured to engage the inner transfer bar.

8. A method of cutting a pattern into a sheet of media, comprising:
placing a media sheet into a media punch, the media punch including an outer cutter configured to cut a fractional outer border pattern in the media sheet, an inner cutter configured to cut a fractional inner pattern in the media sheet, the fractional inner pattern being interior to the fractional outer border pattern within the media sheet, and a selector configured to move between an outer cut position to engage the outer cutter alone, an inner cut position to engage the inner cutter alone, and a combination cut position to engage both the inner cutter and the outer cutter;
moving the selector into a first of the outer cut position, the inner cut position, and the combination cut position; and
actuating a handle to perform a first cut according to the position of the selector.

9. The method of claim 8, further comprising moving the selector into a second of the outer cut position, inner cut position, and the combination cut position, the second of the outer cut position, the inner cut position, and the combination cut position being independently selected from the first of the outer cut position, the inner cut position, and the combination cut position.

10. The method of claim 9, further comprising actuating the handle to perform a second cut on the media sheet, the second cut being separate from the first cut.

11. The method of claim 8, wherein the fractional portion of the outer border pattern is ⅛ of a complete border pattern.

12. The method of claim 8, wherein the fractional portion of the outer border pattern is ¼ of a complete border pattern.

13. The method of claim 8, wherein the first of the outer cut position, the inner cut position, and the combination cut position is the outer cut position, the method further comprising performing a plurality of successive cuts on the media sheet with the selector in the outer cut position to cut a complete outer border pattern.

14. The method of claim 13, wherein eight cuts are made to cut the complete outer border portion.

15. The method of claim 8, wherein the first of the outer cut position, the inner cut position, and the combination cut position is the inner cut position, the method further comprising performing a plurality of successive cuts on the media sheet with the selector in the inner cut position to cut a complete inner pattern.

16. The method of claim 8, wherein the first of the outer cut position, the inner cut position, and the combination cut position is the combination cut position, the method further comprising performing a plurality of successive cuts on the media sheet with the selector in the combination cut position to cut a complete combination pattern.

17. A media punch, comprising:
an outer cutter configured to cut a fractional outer border pattern in a media sheet;
an inner cutter configured to cut a fractional inner pattern in a media sheet, the fractional inner pattern being interior to the fractional outer border pattern within the media sheet;
a selector configured to move between an outer cut position to engage the outer cutter alone, an inner cut position to engage the inner cutter alone, and a combination cut position to engage both the inner cutter and the outer cutter; and
a lever handle operatively associated with the selector, wherein actuation of the lever handle causes the outer cutter to cut the fractional outer border pattern when the selector is at the outer cut position, causes the inner cutter to cut the fractional inner pattern when the selector is at the inner cut position, and causes the inner cutter and the outer cutter to cut the fractional outer border pattern and the fraction inner pattern when the selector is at the combination cut position.

18. The media punch of claim 17, wherein the fractional outer border pattern is ⅛ of a complete border pattern.

19. The media punch of claim 17, wherein the fractional outer border pattern is ⅛ of a complete inner pattern.

20. The media punch of claim 17, wherein the selector is configured to move between successive actuation of the lever handle.
